(19) United States
(12) Patent Application Publication
(10) Pub. No.: US 2017/0193616 A1
(43) Pub. Date: Jul. 6, 2017

(54) REAL-TIME PROPERTY-ASSOCIATED COMMUNICATION SYSTEM

(71) Applicant: NEWHOUSE GROUP, INC., SMYRNA, GA (US)

(72) Inventors: GEMEZ MARSHALL, SMYRNA, GA (US); BRANDEIS MARSHALL, SMYRNA, GA (US)

(21) Appl. No.: 15/285,975

(22) Filed: Oct. 5, 2016

Related U.S. Application Data
(60) Provisional application No. 62/237,023, filed on Oct. 5, 2015.

(51) Int. Cl. G06Q 50/16; G06Q 50/00; G06Q 10/10; G06Q 30/06

(52) U.S. Cl. CPC G06Q 50/16; G06Q 30/0631; G06Q 50/01; G06Q 30/0633; G06Q 10/1095; G06Q 30/0627

(57) ABSTRACT

Disclosed are various embodiments for a real-time property-associated communication system for properties for sale or lease. The platform described herein facilitates the discovery of property listings and the publishing of notifications relating to potential buyer's interactions with the property listings electronically and also physical visits. Transactions may be initiated and consummated electronically via this platform. Also, this platform may integrate with social networks.

### CROSS-REFERENCE TO RELATED APPLICATIONS

The present application claims the benefit of U.S. Provisional Application No. 62/237,023 entitled “A System and Method for Publishing Market Activities of Items for Sale or Lease” and filed Oct. 5, 2015, which is incorporated herein by reference in its entirety.

### BACKGROUND

The buying and selling of real estate has traditionally involved the services of buyer agents and seller agents. Seller agents are tasked with preparing a property to be listed for sale, including setting an asking price and coordinating photography, signs, advertising, staging, and open houses. Buyer agents, by contrast, represent particular potential buyers and take them from property to property while providing recommendations. While property listing databases (e.g., Multiple Listing Service (MLS)) were limited to access by agents in years past, present network services like ZILLOW and TRULIA allow buyers to search and browse property listings with rich multimedia.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of a networked environment according to various embodiments of the present disclosure.

FIGS. 2A-2G are pictorial diagrams of example user interfaces rendered by a client in the networked environment of FIG. 1 according to various embodiments of the present disclosure.

FIGS. 3A-3D are flowcharts illustrating examples of functionality implemented as portions of a property listing platform service executed in a computing environment in the networked environment of FIG. 1 according to various embodiments of the present disclosure.

FIG. 4 is a schematic block diagram that provides one example illustration of a computing environment employed in the networked environment of FIG. 1 according to various embodiments of the present disclosure.

### DETAILED DESCRIPTION

The present disclosure relates to a real-time, property-associated communication system used to facilitate real estate transactions. Although electronic property listing platforms exist, at present they are little more than searching and browsing platforms for potential buyers to discover properties of interest. All transactions and communications are handled manually, out-of-band through interactions with agents.

With the present system of seller and buyer agents, there are great impediments to developing a system that facilitates transactions purely electronically and on an automated basis, like a site like EBAY does with respect to the sale of goods. Any electronic system must have the support of real estate agents in order to be successful. If agents' interests and livelihoods are not protected, there is little incentive for their participation. Without their participation, such a system would not achieve a critical mass of listings to be successful or useful to potential buyers.

Various embodiments of the present disclosure introduce a new real-time property-associated communication system for use in conjunction with a property listing platform. In an embodiment, sellers are able to receive real-time notifications that potential buyers are currently visiting their properties or that potential buyers are meeting a threshold for engagement with their electronic property listings. However, in order to protect the agent system, the communications are anonym ized with respect to the buyers, and the buyers are identified by their agents. At the same time, more detailed information can be shared with the buyer's agents and/or other agents on their team. Further, in recognition that a buyer often involves a “team” (e.g., husband and wife, roommates, business partners, etc.), more detailed information can be shared with other individuals on the buyer's team. In some cases, information can be made available publicly to other potential buyers.

Likewise, potential buyers are able to receive real-time notifications from the seller or seller's agent. For example, a selling team may send a notification to a buying team during their showing and entice them to submit an offer. In order to protect the seller's identity, the notification will present the information of the seller's agent in lieu of personally identifying information of the seller.

In addition to providing notifications, various embodiments facilitate initiating real estate transactions online. For example, a buyer may tender an offer for purchase or rental of a property online, and a seller can accept the offer or tender a counteroffer, also online. The communications relative to the transactions can be mediated or moderated by the respective buyer and seller agents electronically. Further, information about the fact of an offer may be made publicly viewable to other potential buyers in order to stimulate competitive interest. Additionally, competitive interest can be enticed by sending notifications related to other buying actions (e.g., listings being watched, showings being schedules) prior to an offer being submitted. Such notifications may, for example, be sent to competing buyers, their agents, and related team members.

In various embodiments, social network integrations may be provided to assist potential buyers and potential sellers with the discovery of agents that their friends on the social network may be using. Various facts, such as a property going under contract or having a transaction consummated, may be published to friends, along with identifications of corresponding agents. In the following discussion, a general description of the system and its components is provided, followed by a discussion of the operation of the same.

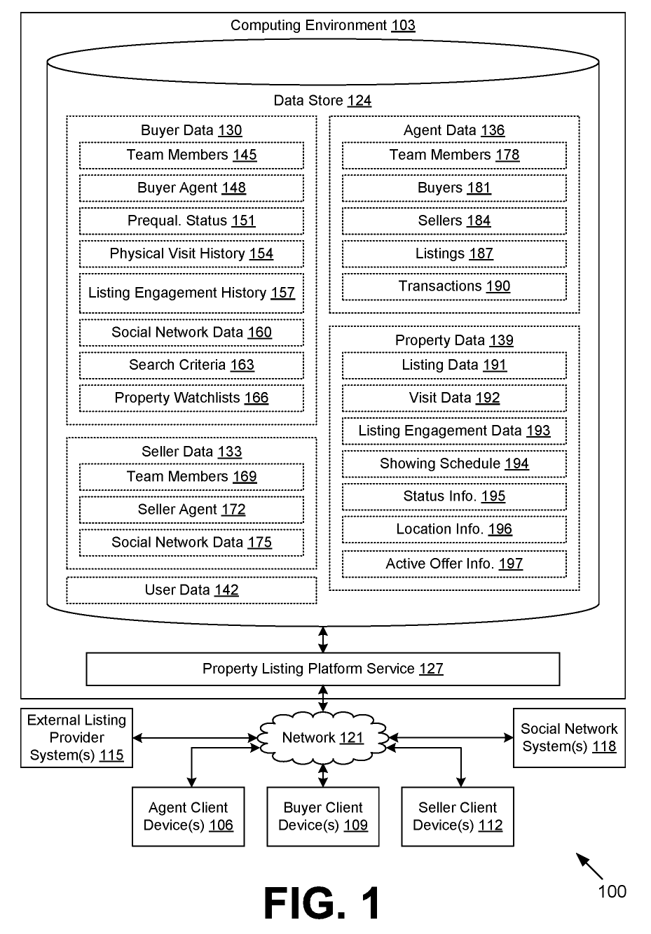

With reference to FIG. 1, shown is a networked environment 100 according to various embodiments. The networked environment 100 includes a computing environment 103, one or more agent client devices 106, one or more buyer client devices 109, one or more seller client devices 112, one or more external listing provider systems 115, and one or more social network systems 118, which are in data communication with each other via a network 121. The network 121 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 103 may comprise, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 124 that is accessible to the computing environment 103. The data store 124 may be representative of a plurality of data stores 124 as can be appreciated. The data stored in the data store 124, for example, is associated with the operation of the various applications and/or functional entities described below. Non-limiting examples of commercially available technologies used in the data store 124 may include APACHE CASSANDRA (or other relational database management system), APACHE SOLR (or other search engine), APACHE KAFKA (or other queue platform), and others.

The components executed on the computing environment 103, for example, include a property listing platform service 127 and other applications, services, processes, systems, engines, or functionality not discussed in detail herein. The property listing platform service 127 is executed to provide functionality involving real-time communications and transactions, search, browse, and other activities with respect to property listings as will be described. Although the property listing platform service 127 is described herein as a single service, the property listing platform service 127 may be structured as multiple different applications, processes, services, systems, engines, or modules in various implementations. In one specific implementation, the property listing platform service 127 is implemented in part using a RUBY-ON-RAILS application server, along with APACHE STORM to process streaming data in real-time.

The data stored in the data store 124 includes, for example, buyer data 130, seller data 133, agent data 136, property data 139, user data 142, and potentially other data. To begin, the buyer data 130 includes a variety of data about users of the system who happen to be buyers, potential buyers, lessees, or potential lessees of properties. Included within the buyer data 130 may be data regarding team members 145, a buyer agent 148, a prequalification status 151, a physical visit history 154, a listing engagement history 157, social network data 160, search criteria 163, property watchlists 166, and/or other data.

The team members 145 may identify various users who are considered members of the buyer's team, so to speak. This recognizes that buyers may include husband and wife teams, business and familial partnerships, and other associations among multiple people. Associated with the team members 145 may be various parameters that give permissions or restrict functionality with respect to particular team members. In some cases, all team members 145 may have equal permissions, while in other cases, one or more team members 145 may be restricted. For example, a person may shop for a home along with his friend, who is giving advice. Although the person may wish for his friend to be included on all communications, the friend should not be given permission to bind the person with respect to transactions. By contrast, with a joint venture, affirmative permission from all team members 145 may be required to enter into a transaction.

A buyer may be associated with one or more buyer agents 148. In some cases, a buyer may enter into an exclusive representation agreement with a particular buyer agent 148. In other cases, the buyer may utilize multiple buyer agents 148, where each buyer agent 148 has rights to transactions with respect to particular properties. In some cases, a buyer may be unrepresented by an agent and may work with the listing agent of a property directly.

A buyer may be associated with a prequalification status 151, which may be a loan amount for which the buyer is approved or preapproved. The prequalification status 151 may indicate a maximum amount of purchase price or rental price that the buyer can afford, considering a down payment and the buyer's documented income. The prequalification status 151 may be associated with several restrictions, such as only Federal Housing Association (FHA)-approved properties can be considered, or that the properties must meet flood plain criteria, etc. The prequalification status 151 may be used to preclude buyers from tendering offers on properties for which they are not prequalified, and/or to inform sellers in an automated way that the buyers are prequalified for their properties.

The physical visit history 154 may track various information about a buyer's visit to one or more properties. For example, the buyer client device 109 may include a location-finding subsystem (e.g., a global positioning system (GPS) device, cellular triangulation, wireless access point triangulation, etc.) that tracks when the buyer is at a listed property. The physical visit history 154 may record dates and times of a buyer's visit, length of the buyer's visit, the buyer's route around the property, and other information, which may be used to gauge the buyer's level of interest in the property, and in the aggregate, the level of buyer interest across multiple potential buyers.

Similarly, the listing engagement history 157 may track various information about a buyer's engagement with an electronic listing. For example, the listing engagement history 157 may record the length of time that a listing user interface has been visible upon a display of a buyer client device 109, how many images from the listing have been viewed or clicked through by the client, dates and times of the engagements as well as frequency, any hovering over user interface elements related to the listing, any copying of images or text related to the listing, whether the buyer shared the listing with other users via the property listing platform service 127 or via social network, whether other users have viewed the listing after referral by the buyer (e.g., token identifier embedded in uniform resource locator (URL) shared with others), and/or other information.

The social network data 160 includes information about social network platforms linked to the buyer that the buyer has elected to share. This information may include contact information for other users within a circle of friends.

The search criteria 163 include stored and/or otherwise entered criteria supplied by buyers in their search for listings via the property listing platform service 127. The search criteria 163 may include, for example, whether there is an active offer and criteria related to the active offer (e.g., offer price, offer deadline), whether a listing is watched by a potential buyer, minimum price, maximum price, geographic area criteria (e.g., ZIP code, city and state), number of bedrooms, number of bathrooms, average utility bills, whether a specified utility is available (e.g., natural gas, fiber broadband), year constructed, type of property (e.g., single family detached, condominium, townhome, vacant land, mobile home), living area, type of garage or carport, number of kitchens, whether a pool is available, whether a fireplace is available, whether tennis courts are available, homeowner's association fees, siding type or other construction parameters, roof age, sewer or septic availability, and/or other criteria.

The property watchlists 166 are lists of properties that have been selected as favorites by the buyer or one or more team members. The properties may be manually selected for inclusion on the property watchlist 166, or the properties may be automatically selected by matching search criteria 163 or by virtue of a level of engagement seen in the listing engagement history 157 or through a visit recorded in the physical visit history 154. When on a property watchlist 166, various changes in status of a property or a competing user's engagement relative to a property (e.g., making an offer, scheduling a showing, etc.) may be published as notifications to the buyer and associated team members.

The seller data 133 includes a variety of data about users of the system who happen to be sellers or lessors of properties (generally, “offerors” of properties). The seller data 133 may include, for example, data related to team members 169, a seller agent 172, social network data 175, and/or other data. Like buyers, sellers may be associated with multiple team members 169, who may be co-owners or simply persons associated with or interested in helping the seller. The seller agent 172 corresponds to a listing agent for one or more properties that the sellers is selling or leasing. The social network data 175 includes information about social network platforms linked to the seller that the seller has elected to share. This information may include contact information for other users within a circle of friends.

The agent data 136 includes a variety of data about users of the system who are real estate agents. These agents may be listing agents for some properties, while representing buyers for other properties. Included within the agent data 136 may be data related, for example, to team members 178, buyers 181, sellers 184, listings 187, transactions 190, and/or other data. Like the buyers and sellers, the agents may be associated with one or more other users who are team members 178. For example, a busy agent may have a team with multiple other agents and/or support staff that assist the agent. In some cases, the team members 178 may correspond to all members of a particular brokerage office.

A given agent may represent one or more buyers 181 seeking to purchase and/or lease property and/or one or more sellers 184 seeking to sell or lease out property. Further, an agent may have one or more listings 187 of properties. These listings 187 may be involved in one or more current transactions 190, including a sale transaction or a lease transaction. In some cases, a listing 187 may have multiple transactions 190, including backup transactions 190 such as backup offers that will automatically proceed if a prior transaction 190 is not consummated.

The property data 139 includes data relating to properties listed and/or previously listed via the property listing platform service 127. Such properties may include houses, multiplexes, apartments, condominiums, townhouses, mobile homes, vacant land, farms, commercial properties, and so on. The properties may be fee simple interests, life estates, remainder interests, leaseholds, usufructs, timeshares, and/or other types. Included in the property data 139, for example, includes listing data 191, visit data 192, listing engagement data 193, a showing schedule 194, status information 195, location information 196, active offer information 197, and/or other data.

The listing data 191 includes a variety of data in a listing that can be presented via a user interface. This data can include, for example, photographs, video tours, audio tours, asking price, title, description, address, square feet/area, numbers of bedrooms and bathrooms, whether a pool is present, property taxes, previous sales information, previous valuations, and/or other information. Portions of the listing data 191 may be viewable only by agents, sellers, and/or buyers, as well as team members 145, 169, 178.

The visit data 192 may track numbers of buyers and potentially their identities who have visited the property, either during a showing or during an informal visit. The visit data 192 may include lengths of the visit and portions of the property visited. For example, the visit data 192 may indicate that three buyers visited the property, but stayed only five minutes on average and left after seeing the kitchen. The listing engagement data 193 may track numbers of buyers and potentially their identities who have viewed or interacted with the electronic listing, including types of interactions and lengths. For example, the listing engagement data 193 may indicate that 256 buyers have visited the electronic listing, that the average time interacting with the listing was two minutes, and that ten buyers in particular (with their identities) added the property to their property watchlists 166 or met other threshold criteria for engagement.

The showing schedule 194 may give a calendar of showing availabilities. The showing schedule 194 may indicate when the property is available and/or is unavailable. The status information 195 indicates a current status of the property, which could include, for example, newly listed, listing updated, open house scheduled, under contract, contingent, available, and so on. The location information 196 may include coordinates of the property. In some cases, the location information 196 may include locations of particular rooms or a geofence of the property or the rooms. Thus, using the location information 196, it can be determine whether a user has entered the property, left the property, entered a specific area of the property, exited a specific area of the property, and so on.

The active offer information 197 includes various information about offers to purchase or lease the property that may be active or pending. Such offers may be accepted by the seller, pending acceptance or rejection by the seller, or rejected by the seller. The offers may be associated with deadlines for acceptance. The fact of a pending active offer and its associated deadlines may be published to users of the system, including competing buyers. However, in one embodiment, the competing buyers are not made aware of the value of the pending active offer in order to stimulate completive interest, even if, for example, the value of the pending active offer is unreasonably low.

The user data 142 includes various information about users of the system, which may include buyers 181, sellers 184, agents, or team members 145, 169, 178. The users may be registered or unregistered. Activities of the users may be tracked via explicit login or implicitly via cookies. The user data 142 may include profile and contact information (e.g., name, address, email address, phone number, fax number, etc.), security credentials such as usernames and passwords, and/or other data.

The agent client devices 106, the buyer client devices 109, and the seller client devices 112 are representative of a plurality of client devices that may be coupled to the network 121. The agent client devices 106, the buyer client devices 109, and the seller client devices 112 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The agent client devices 106, the buyer client devices 109, and the seller client devices 112 may include a display comprising, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The agent client devices 106, the buyer client devices 109, and the seller client devices 112 may be configured to execute various applications such as a client application and/or other applications. The client application may be executed in the agent client devices 106, the buyer client devices 109, and the seller client devices 112, for example, to access network content served up by the computing environment 103 and/or other servers, thereby rendering a user interface on the display. To this end, the client application may comprise, for example, a browser, a dedicated application, etc., and the user interface may comprise a network page, an application screen, etc. The agent client devices 106, the buyer client devices 109, and the seller client devices 112 may be configured to execute applications beyond the client application such as, for example, web services, email applications, social networking applications, word processors, spreadsheets, and/or other applications.

The external listing provider systems 115 and the social network systems 118 may comprise, for example, a server computer or any other system providing computing capability. Alternatively, the external listing provider systems 115 and the social network systems 118 may employ a plurality of computing devices that may be arranged, for example, in one or more server banks or computer banks or other arrangements. Such computing devices may be located in a single installation or may be distributed among many different geographical locations. For example, the external listing provider systems 115 and the social network systems 118 may include a plurality of computing devices that together may comprise a hosted computing resource, a grid computing resource, and/or any other distributed computing arrangement. In some cases, the external listing provider systems 115 and the social network systems 118 may correspond to an elastic computing resource where the allotted capacity of processing, network, storage, or other computing-related resources may vary over time.

The external listing provider systems 115 are configured to provide listing data 191 from an external provider, such as a Multiple Listing Service (MLS). For example, the external listing provider systems 115 may provide periodic data feeds with updated information from the listing data 191. Although the listing data 191 may be created via the property listing platform service 127, integration with the external listing provider systems 115 enables the use of existing legacy systems that provide listing data 191.

The social network systems 118 are configured to provide access to social network services for social network integrations. The social network systems 118 may facilitate obtaining profile information from users, use of a federated identity login, obtaining lists of friends for a user, publishing items to a user's data feed, sharing items with friends of a user, and/or other activities.

Next, a general description of the operation of the various components of the networked environment 100 is provided. To begin, listing data 191 is on-boarded onto the system, potentially via a data feed from an external listing provider system 115. Users are able to create user accounts, and relationships among users and properties are designated. For instance, upon registration, listing agents and sellers are able to claim listings in the listing data 191 with which they are associated. Users can also indicate team members 145, 169, 178 with whom they are sharing information and/or rights. The team members 145, 169, 178 may be existing users or may be designated through a medium of communication by which they can be on-boarded at a later time.

Potential buyers may begin interacting with the property listing platform service 127 through a series of network pages and/or a dedicated client application. For example, a buyer user may use a buyer client device 109 to execute a property listing search or to access a URL for a specific listing. The user may search by entering various search criteria 163, which may include specific addresses or location finding via a map. Ultimately, the user is able to see information from a property listing (i.e., the listing data 191) in a user interface. To see certain information or to perform certain activities, the user may be asked to register as a buyer and create an account via the property listing platform service 127.

Upon creating an account via the property listing platform service 127, the buyer's activities can be tracked in the physical visit history 154, the listing engagement history 157, the search criteria 163, and the property watchlists 166. In some cases, the previous activities associated with the buyer client device 109 via a tracking cookie may also be on-boarded to the account. The user can also define a relationship with one or more buyer agents 148 with respect to one or more properties.

Also, as the buyer interacts with an electronic listing, various real-time notifications can be automatically generated by the property listing platform service 127. These notifications may include email messages, phone calls, text messages, notifications via a web page, and so forth.

To begin with, real-time notifications can be sent to the seller, the seller's agent, and/or the team members 178 of the seller's agent for the property. Such a notification may excite the seller and indicate that potential buyers are interested enough in the electronic listing to interact with it. For privacy concerns, these notifications will not include (or will mask) the potential buyer's identifying information. While masking or anonymizing the potential buyer's identifying information, an identification of the buyer agent 148 may be included. In addition to addressing privacy concerns, this prevents direct communication between buyers and sellers that could result in transactions happening outside the control of the agents involved.

These notifications may include non-identifying characteristics of the potential buyer, such as, for example, other properties visited by or with listings viewed by the buyer, search criteria 163 used by the buyer to arrive at the listing, prequalification status 151, other properties on the property watchlist 166 of the buyer, browsing habits of the buyer, and so on. The notifications can also include specifics as to the particular engagement with the electronic listing such as, for example, time spent viewing the electronic listing, time spent viewing specific items of the electronic listing, repeat visits, whether items or the listing were shared with others via a social network or other team members 145, whether photographs were viewed, and so on. In some cases, these notifications may be triggered upon the buyer interacting with the particular listing and meeting a predefined threshold for sufficient engagement, e.g., explicitly adding the property to a property watchlist 166, spending more than five minutes viewing the listing, viewing the listing more than once via a bookmark (i.e., no referring URL found), and so forth.

In one embodiment, the property listing platform service 127 may enable an anonymized communication between the buyer and the seller, seller's agent, and/or team members 178 such that the buyer can ask questions and receive answers. This communication may be moderated via the buyer's agent and/or team members 178 of the buyer's agent in some scenarios.

Next, notifications in this situation may also be sent to the buyer's agent, team members 178 of the buyer's agent, and/or team members 145 of the buyer. Unlike the notifications to the seller, seller's agent, and/or team members 178 of the seller's agent, these notifications will include an identification of the buyer. This enables the team members 178 of the buyer's agent, and/or team members 145 of the buyer to follow up with the buyer to answer any questions. Along with automatically generated notifications upon meeting a threshold for engagement, the property listing platform service 127 may allow communication between a buyer and the buyer's agent, team members 178 of the buyer's agent, and/or team members 145 of the buyer in order to ask questions or to note the listing for future references.

Similarly, real-time notifications can be sent to competing buyers, the competing buyer's agent, and/or the team members 178 of the competing buyer's agent for the property. Such a notification may warn the competing buyer and indicate that a potential buyer is interested enough in the listing to interact with it on their buyer client device 109 or visit the property. For privacy concerns, these notifications may not include (or may mask) the potential buyer's identifying information. While masking or anonymizing the potential buyer's identifying information, an identification of the buyer agent 148 may be included.

The property listing platform service 127 also can facilitate scheduling showings for buyers of properties. While vacant properties can be seen at nearly anytime depending on the buyer's and buyer agent's schedules, scheduling showings of occupied properties has typically been a challenge. The property listing platform service 127 as described facilitates automating the scheduling of showings on the basis of a calendar provided by seller, potentially a calendar provided by a seller's agent, along with an intersection of the buyer's agent's calendar. In this way, a showing schedule 194 can be generated.

A user interface generated by the property listing platform service 127 can show open times. Also, the user interface can suggest times to potential buyers that are adjacent to times at which showings are already scheduled by other potential buyers. This consolidates the showing times to simplify the times at which the seller is expected not to be at the property or otherwise to make the property available for showings.

In addition to scheduled showings, buyers may sometimes visit a property unannounced or attended by a buyer's agent. If not attended, the buyers may still walk the property to observe it. The property listing platform service 127 is configured to track these physical visits to the property via the physical visit history 154. For example, the property listing platform service 127 may receive a location of the buyer from a client application executed by the buyer client device 109. This location may be generated automatically via a location-finding subsystem of the buyer client device 109. When the location is within the location of a property as recorded in the location information 196, the property listing platform service 127 is able to record that the buyer has entered the property. Where specific geofences or boundaries of rooms or other features of the property, the property listing platform service 127 may record entrances and exits relative to these features. The property listing platform service 127 may also record a path taken by the buyer and the buyer client device 109 as the property is traversed. When the buyer exits, that fact may also be recorded.

In addition to recording the facts relating to the visit in the physical visit history 154, the property listing platform service 127 may also initiate notifications to other users relative to the physical property visit. Real-time notifications can be sent to the seller, the seller's agent, and/or the team members 178 of the seller's agent for the property. Such a notification may excite the seller and indicate that potential buyers are interested enough to physically visit the property. For privacy concerns, these notifications will not include (or will mask) the potential buyer's identifying information. While masking or anonymizing the potential buyer's identifying information, an identification of the buyer agent 148 may be included. In addition to addressing privacy concerns, this prevents direct communication between buyers and sellers that could result in transactions happening outside the control of the agents involved.

These notifications may include non-identifying characteristics of the potential buyer, such as, for example, other properties visited by or with listings viewed by the buyer, search criteria 163 used by the buyer to arrive at the listing, prequalification status 151, other properties on the property watchlist 166 of the buyer, browsing habits of the buyer, and so on. The notifications can also include specifics as to the physical visit such as, for example, time spent visiting the property, time spent in particular areas of the property, a path taken by the buyer in traversing the property, and so on. In some cases, notifications may be sent to competing buying teams, including competing buyers, competing buyer agents, team members of 145 of competing buyers, and team members 178 of competing buyer agents. Similarly, the identity of the buyer who caused the notification is masked and replaced with an identification of the buyer's agent.

Notifications in this situation may also be sent to the buyer's agent, team members 178 of the buyer's agent, and/or team members 145 of the buyer. Unlike the notifications to the seller, seller's agent, and/or team members 178 of the seller's agent, these notifications will include an identification of the buyer. This enables the team members 178 of the buyer's agent, and/or team members 145 of the buyer to follow up with the buyer to answer any questions. Along with automatically generated notifications upon a physical visit, the property listing platform service 127 may allow communication between a buyer and the buyer's agent, team members 178 of the buyer's agent, and/or team members 145 of the buyer in order to ask questions or to note the property for future references.

The property listing platform service 127 is also configured to facilitate transactions relative to properties, such as a buyer tendering an offer, a seller accepting the offer, a seller tendering a counteroffer, a buyer accepting a counteroffer, contact modifications in response to inspections, appraisals, or financing contingencies, and so forth. Such contracts created herein can be for the purchase or lease of property.

When a notification of a buyer's offer is sent to the seller, the seller's agent, and/or the team members 178 of the seller's agent, the notification may include the prequalification status 151 of the buyer in order to vouch for or otherwise support the buyer's offer. In some cases, the property listing platform service 127 may be configured to prevent buyers from placing offers when they are not appropriately prequalified. For instance, if a buyer wishes to place an offer for a house for $75,000, the property listing platform service 127 may be configured to verify that the buyer is prequalified in the prequalification status 151 for at least a $75,000 purchase. Like other notifications, offer notifications may be configured to mask the identity of the buyer and include only an identification of the buyer's agent.

Offers can be sent in real-time to seller client devices 112 and to agent client devices 106, and the seller is able to accept the offer, or counter, electronically via a user interface. Accepting or countering may involve replying to a text message, clicking a button labeled “accept” or “counter,” replying to a speech interface using a voice command, and/or other actions. The offers as presented may be associated with a deadline for acceptance. In some scenarios, the deadline may expire and the property listing platform service 127 can facilitate extension of the offer deadline. The offer deadline may be published as a notification to other parties such as other buyers, their agents, and any team members. If changed, the change of the offer deadline may also be published to these interested parties.

The status information 195 can be updated in real-time regarding the status of the property transaction. The fact of a pending offer may result in published real-time notifications to one or more buyers for whom the property has been added to a property watchlist 166 or otherwise who have expressed at least a threshold level of interest in the property. When the fact of a pending offer is made known, potential buyers who are “on the fence” may be motivated to submit competing offers at the same time. This may result in higher or better offers than otherwise would be made.

The notifications described herein as performed by the property listing platform service 127 may be made via a social network system 118 in some embodiments. In integrating with a social network system 118, the property listing platform service 127 may publish publicly or to a circle of friends that a seller or seller's agent has listed a property, that a buyer has visited a property, that a seller, a buyer, buyer's agent, or seller's agent has an executed contract for a property, that a seller, a buyer, buyer's agent, or seller's agent has closed a sale or lease transaction for a property, and so forth. Such notifications may be performed automatically or upon manual confirmation by a user. The notifications may include links in order for users to view the electronic listing via the property listing platform service 127 and/or to learn more information about a seller's agent or buyer's agent involved in the transaction (e.g., via the agent's web page or social network profile).

The property listing platform service 127 may generate various user interfaces that indicate agent performance and track record. Various statistics about agents may include days a listing was on the market, asking price, sales price, closings, and so forth.

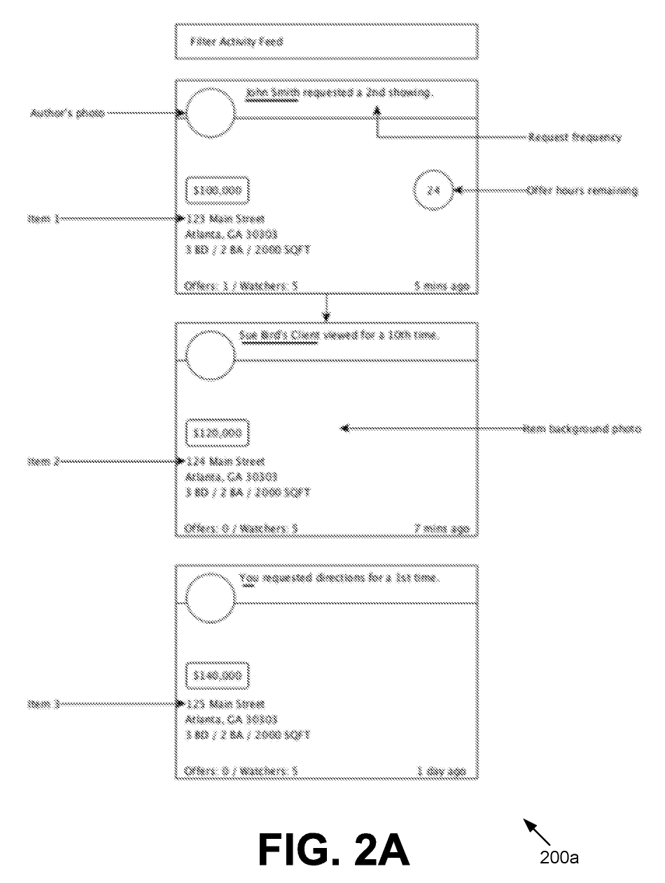

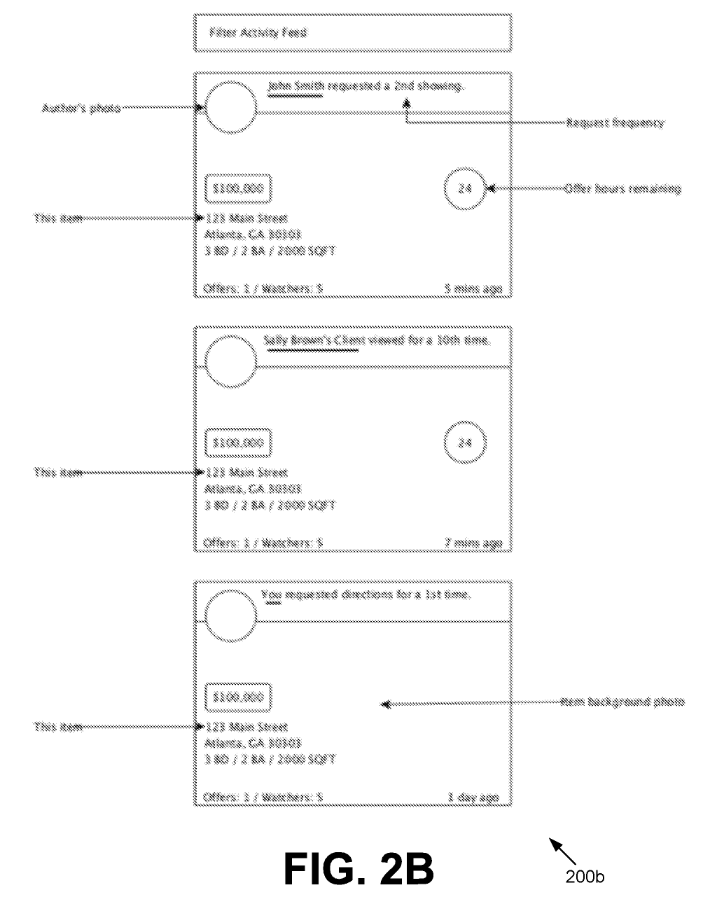

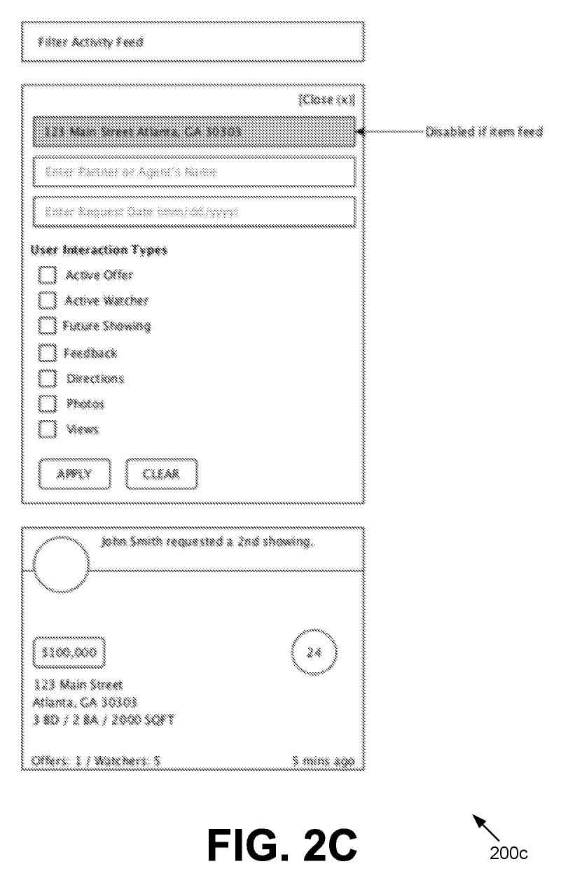

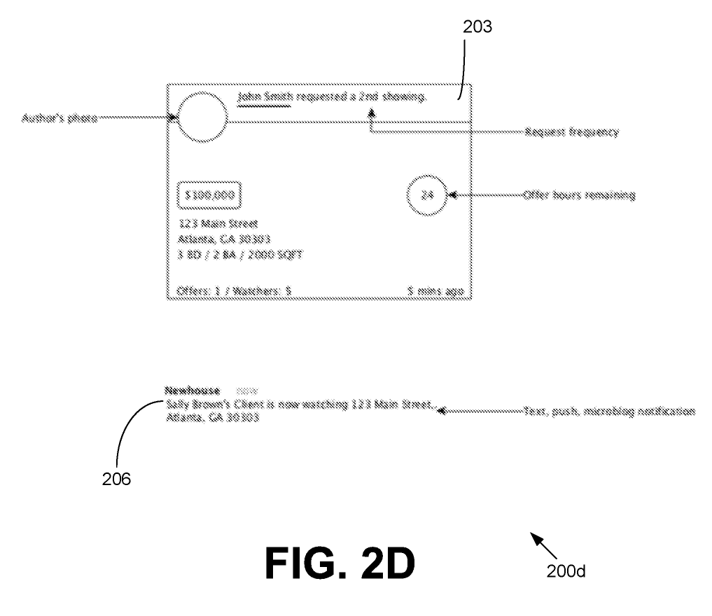

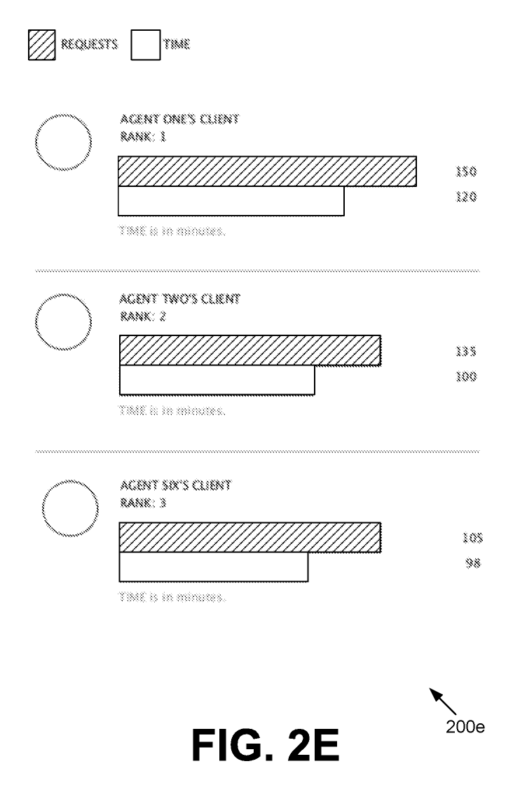

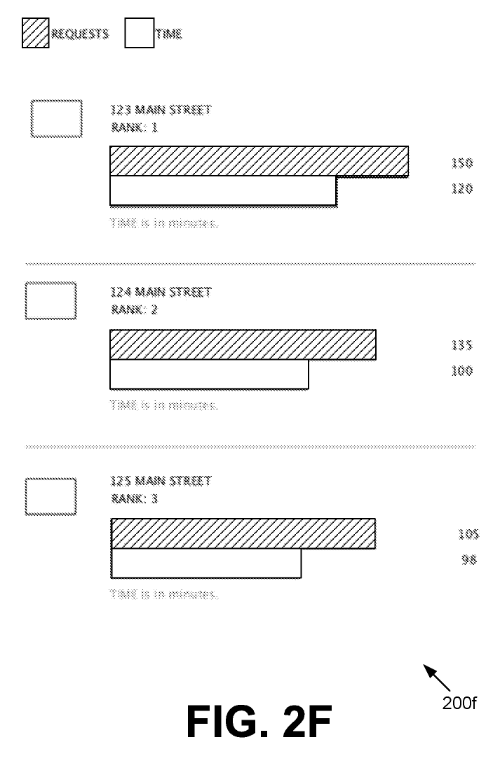

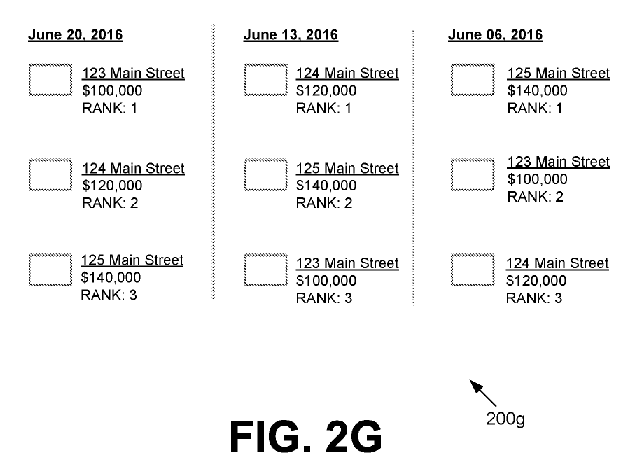

Referring now to FIG. 2A, shown is an example user interface 200a of an activity feed of a user. Each user can have one or more personal feeds to receive property notifications. For example, a potential home buyer may be searching in a new city, state, or school district. Simultaneously, the user can have feed to track the activity on the house they are selling. Likewise, listing agents have feeds to watch potential buyers. Buyer agents have feeds to see which properties interest their clients. As shown, the activity feed can include notifications that a user has requested a showing with a request frequency, a user has viewed a listing a number of times, that to the property has been requested by the current user for a number of times, among other information. FIG. 2B shows a similar example user interface 200b of an activity feed specific to a property listing.

FIG. 2C shows an example filtering user interface 200c for activity feeds of a user. For personal feeds, activities can be limited by property, user, request date, or interaction type. Interaction types can include active offers, active watchers, future showings, feedback, directions, photos, and views.

FIG. 2D shows example user interfaces 200d for notifications. Email notifications 203 may resemble feed entries. Text, push, and microblog notifications 206 may include the actionable portion of the activity.

FIG. 2E shows an example user interface 200e that presents trends respect to potential buyers, where the buyer's identities are hidden and only the identity of the buyer's agent is shown. In order to promote some degree of competition interest, buyers are ranked by interest levels. Interaction time and number of online requests may be interest factors, among others.

FIG. 2F shows an example user interface 200f that presents trends respect to properties. Each property that a user interacts with gets ranked to identify their level of interest. This could be useful for a buyer's agent and partner. It could also show sellers and listing agents how their property compares to the potential buyer's favorites.

FIG. 2G shows an example user interface 200g that presents comparable trends respect to properties. For properties within a given category, a user may want to see how they compare on a weekly basis. Categories can include product type, color, location, and more.

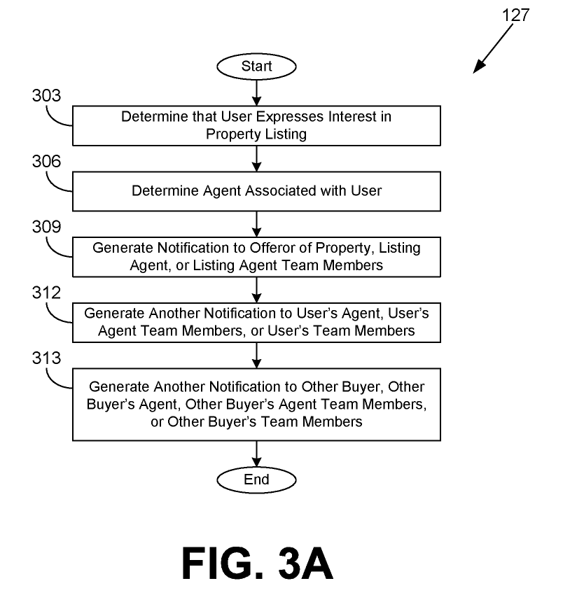

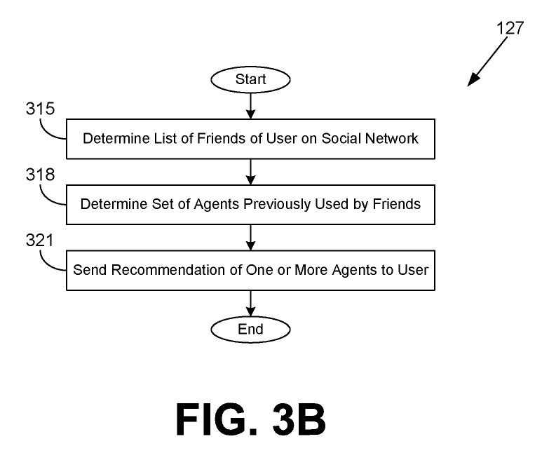

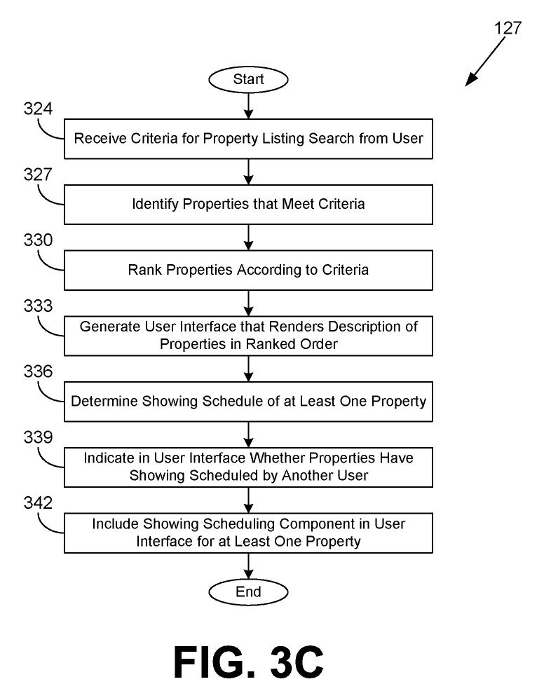

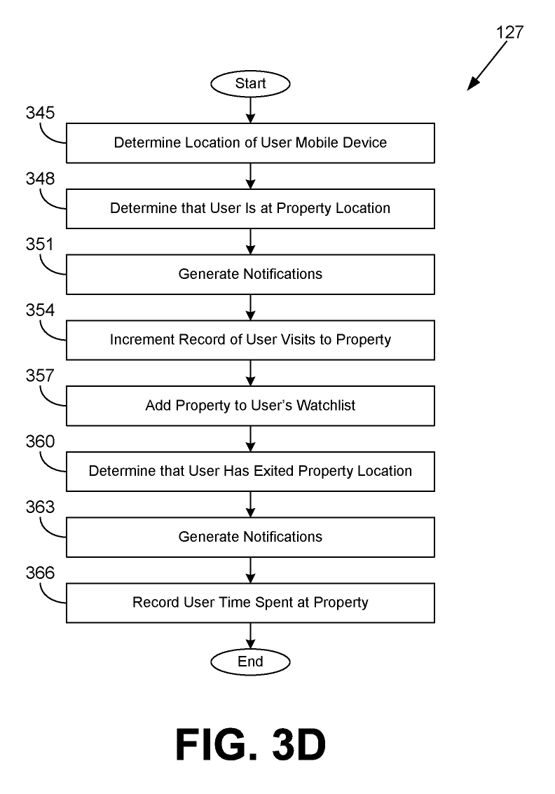

Referring next to FIG. 3A, shown is a flowchart that provides one example of the operation of a portion of the property listing platform service 127 according to various embodiments. It is understood that the flowchart of FIG. 3A provides merely an example of the many different types of functional arrangements that may be employed to implement the operation of the portion of the property listing platform service 127 as described herein. As an alternative, the flowchart of FIG. 3A may be viewed as depicting an example of elements of a method implemented in the computing environment 103 (FIG. 1) according to one or more embodiments.

Beginning with box 303, the property listing platform service 127 determines that a user, such as a potential buyer or lessee, expresses an interest in a property listing. For example, the user may interact with an electronic user interface corresponding to an electronic listing such that the interaction meets a threshold. To illustrate, if the listing has 25 photographs, and the user views at least 12 of them, that may be sufficient to express an interest. In some cases, the user may perform an action such as adding the property to a property watchlist 166 or sharing the listing via a social network system 118 which may express an interest. Alternatively, if the user engages with the listing for at least a threshold time (e.g., five minutes) or a time relative to that of other users with respect to the listing, that may be sufficient to express an interest. As another alternative, if the user physically visits the property, that may be sufficient to express an interest in the property.

In box 306, the property listing platform service 127 determines an agent associated with the user, such as a buyer agent 148. However, in some cases, the user may be unrepresented.

In box 309, the property listing platform service 127 may generate one or more notifications to the offeror of the property (e.g., the seller or lessor), one or more team members 169 of the offeror of the property, a listing agent, and/or one or more team members 178 of the listing agent. These notifications include an identification of the buyer agent 148 or indicate that the buyer is unrepresented. However, these notifications do not include an identification of the user (e.g., any personally identifying information). The notifications may include metrics or other characteristics of the user that are not personally identifying, such as length of time that the user has interacted with the user interface corresponding to the property listing, length of time that the user visited the property location, prequalification status 151, and so forth. The notifications may be sent by text message, phone call, a data feed in a web page, a social network system 118, email, or via other communications media.

The notifications may be sent based at least in part on selection criteria specified by the recipient or another user. For example, the seller's agent may designate that all of his or her notifications for one or more listings are to be copied to an associate who is a team member 178. The selection criteria may include thresholds for expression of interest (e.g., time spent looking at the listing or visiting), thresholds for prequalification status 151, and/or other selection criteria. Where a user receives several notifications via a data feed, the notifications may be ranked by various ranking criteria such as prequalification status 151, seriousness as expressed by levels of interest (e.g., length of engagement or quantity of engagements), asking price of the listing, recency, and/or other user-specified criteria.

In box 312, the property listing platform service 127 generates another one or more notifications to the user's agent (i.e., the buyer agent 148), one or more team members 178 of the buyer's agent, and/or one or more team members 145 of the user. Unlike the notifications of box 309, these notifications may include an identification of the user so that the buyer's agent or others may personally follow up with the user. The notifications may include metrics or other characteristics of the user, such as visit length, engagement duration with the listing, and so forth. The notifications may be sent by text message, phone call, a data feed in a web page, a social network system 118, email, or via other communications media. The notifications may be triggered by a positive action taken by the user, e.g., selecting a user interface component labeled “notify my team about this listing.”

These notifications may be sent based at least in part on selection criteria specified by the recipient or another user and/or criteria specified by the buyer. For example, the buyer's agent may designate that all of his or her notifications for one or more buyers are to be copied to an associate who is a team member 178. The selection criteria may include thresholds for expression of interest (e.g., time spent looking at the listing or visiting), thresholds for prequalification status 151, and/or other selection criteria. Where a user receives several notifications via a data feed, the notifications may be ranked by various ranking criteria such as prequalification status 151, seriousness as expressed by levels of interest (e.g., length of engagement or quantity of engagements), asking price of the listing, recency, and/or other user-specified criteria.

In box 313, the property listing platform service 127 may generate one or more notifications to competing buyers of the property, one or more team members 145 of the competing buyer, a competing buyer's agent, and/or one or more team members 178 of the competing buyer's agent. These notifications may include an identification of the buyer agent 148 or indicate that the buyer is unrepresented. However, these notifications do not include an identification of the user (e.g., any personally identifying information). The notifications may include metrics or other characteristics of the user that are not personally identifying, such as length of time that the user has interacted with the user interface corresponding to the property listing, length of time that the user visited the property location, prequalification status 151, and so forth. The notifications may be sent by text message, phone call, a data feed in a web page, a social network system 118, email, or via other communications media.

The notifications may be sent based at least in part on selection criteria specified by the recipient or another user. For example, the competing buyer's agent may designate that all of his or her notifications for one or more clients are to be copied to an associate who is a team member 178. The selection criteria may include thresholds for expression of interest (e.g., time spent looking at the listing or visiting), thresholds for prequalification status 151, and/or other selection criteria. Where a user receives several notifications via a data feed, the notifications may be ranked by various ranking criteria such as prequalification status 151, seriousness as expressed by levels of interest (e.g., length of engagement or quantity of engagements), asking price of the listing, recency, and/or other user-specified criteria. Thereafter, the operation of the portion of the property listing platform service 127 ends.

Turning now to FIG. 3B, shown is a flowchart that provides one example of the operation of another portion of the property listing platform service 127 according to various embodiments. It is understood that the flowchart of FIG. 3B provides merely an example of the many different types of functional arrangements that may be employed to implement the operation of the portion of the property listing platform service 127 as described herein. As an alternative, the flowchart of FIG. 3B may be viewed as depicting an example of elements of a method implemented in the computing environment 103 (FIG. 1) according to one or more embodiments.

Beginning with box 315, the property listing platform service 127 determines a list of friends of a user on a social network. For example, a user may have linked a social networking account with the property listing platform service 127, which may be stored in the social network data 160 or 175. The property listing platform service 127 may then request the list of friends via an application programming interface (API) call to one or more social network systems 118 via the network 121.

In box 318, the property listing platform service 127 determines a set of agents previously used by the circle of friends. For example, the agents may have been previously used as buyer's agents to buy property or seller's agents to sell property. The set of agents may be filtered based upon recency among other factors.

In box 321, the property listing platform service 127 sends a recommendation of one or more agents to the user. The recommendation may be sent via the social network system 118, text message, email message, phone call, a notification or feed in a web page, or other approaches. The agent may be recommended based on a variety of factors such as, for example, the geographic location of the agent compared to the user, a promotional consideration provided by the agent, a popularity of the agent, a sales ranking of the agent, whether the agent offers listing services, whether the agent offers buyer representation services, characteristics of agents that the user is looking for (either explicitly provided by the user or implicitly determined), and so on.

Although FIG. 3B describes referrals of agents, it is understood that the property listing platform service 127 may be similarly configured to provide social networking referrals for buyers, renters, and seller's clients. For instance, a potential buyer or a potential seller may be referred to friends who hired local agents, and agents may be referred to friends of their clients. Thereafter, the operation of the portion of the property listing platform service 127 ends.

Continuing on to FIG. 3C, shown is a flowchart that provides one example of the operation of another portion of the property listing platform service 127 according to various embodiments. It is understood that the flowchart of FIG. 3C provides merely an example of the many different types of functional arrangements that may be employed to implement the operation of the portion of the property listing platform service 127 as described herein. As an alternative, the flowchart of FIG. 3C may be viewed as depicting an example of elements of a method implemented in the computing environment 103 (FIG. 1) according to one or more embodiments.

Beginning with box 324, the property listing platform service 127 receives search criteria 163 for a property listing search from a user at a buyer client device 109 via the network 121. For example, the search criteria 163 may include average utility bill amount, asking price, size, geographic location, number of bedrooms and bathrooms, and so forth. In box 327, the property listing platform service 127 identifies a plurality of properties that match the search criteria 163. In some cases, the search criteria 163 may specify characteristics that the user does not like, e.g., having asbestos cement siding, synthetic stucco siding, aluminum wiring, or polybutylene plumbing. Thus, a property listing platform service 127 may receive an undesirable physical characteristic from the user through a user interface, and the property listing platform service 127 may identify the properties such that none of the properties embodies the undesirable physical characteristic.

In box 330, the property listing platform service 127 may rank the properties according to a match quality to the search criteria 163. Also, the property listing platform service 127 may rank the properties based at least in part on a comparison of characteristics of respective property to a set of properties in the data store 124 that the user (or a team member 145 of the user) has physically visited or engaged with a respective listing online. For example, the property listing platform service 127 may rank the properties based at least in part on a corresponding amount of time that the user has interacted with a corresponding user interface for a respective property. Also, the property listing platform service 127 may rank the properties based at least in part on a comparison of a respective asking price of a respective property to an amount of financing for which the user is qualified as indicated in the prequalification status 151. Also, the property listing platform service 127 may rank the listings according to an offer deadline (i.e., a deadline by which all offers must be submitted), and the offer deadline may appear in the listing descriptions. In search results, listings with offers may be ranked to appear at the top of the list.

In box 333, the property listing platform service 127 generates a user interface that renders a description of respective ones of the properties in a ranked order. To this end, the property listing platform service 127 may send data encoding the user interface via the network 121 to a browser or dedicated application executed on a buyer client device 109. In box 336, the property listing platform service 127 determines a showing schedule 194 of one or more properties. Although FIG. 3C describes search as an access point for listing user interfaces, a data feed, property watchlists 166, and direct links may also be used as similar access points.

In box 339, the property listing platform service 127 indicates in the user interface whether the respective properties have one or more showings scheduled by other users, e.g., competing buyers. In some cases, the indication may exclude the exact time of the showing so as to avoid multiple competing buyers being on property at the same time.

In box 342, the property listing platform service 127 includes a showing scheduling component in the user interface to schedule showings for one or more of the listed properties. The showing scheduling component is configured to facilitate scheduling a showing of the corresponding property at an allowable time. The allowable time may be determined based at least in part on an adjacency or proximity of previously scheduled showings of the property to one or more other users. For example, if another user has already scheduled a showing on Saturday at 2 pm, the property listing platform service 127 may recommend a time on Saturday afternoon near to the previously scheduled showing, such that the seller does not have to be absent from the property during disparate times.

Additionally, the allowable times may be determined based on contiguity and availability in the buyer's agent's schedule. This allows consolidation of multiple property visits for a single buyer, and also avoids booking a showing when the buyer's agent is not available. In one embodiment, the showing scheduling component may be disabled for properties for which the amount of financing for which the user is prequalified is less than the asking price, or less than the asking price minus a predefined amount or proportion.

The user interface may also include a component configured to facilitate sending an offer to buy or rent the corresponding property. If an offer is already pending, the component may facilitate sending a backup offer. Activation of this component can cause a notification to be transmitted to the seller, team members 169, the seller's agent, and/or team members 178 of the seller's agent, along with information about the potential buyer. This information may include prequalification status 151, visit length, number of visits, listing engagement metrics, and so forth. The offer may have a particular time open for acceptance. A subsequent user interface on the seller client device 112 may facilitate accepting the offer or countering. In some embodiments, the actions of making an offer, countering, accepting, or declining may be moderated by the buyer's agent or the seller's agent, such that the respective agents must approve the particular action. Thereafter, the operation of the portion of the property listing platform service 127 ends.

Transitioning to FIG. 3D, shown is a flowchart that provides one example of the operation of still another portion of the property listing platform service 127 according to various embodiments. It is understood that the flowchart of FIG. 3D provides merely an example of the many different types of functional arrangements that may be employed to implement the operation of the portion of the property listing platform service 127 as described herein. As an alternative, the flowchart of FIG. 3D may be viewed as depicting an example of elements of a method implemented in the computing environment 103 (FIG. 1) according to one or more embodiments.

Beginning with box 345, the property listing platform service 127 determines a location of a user mobile device (e.g., a buyer client device 109) via a location-finding subsystem of the mobile device. For example, the buyer client device 109 may be configured to periodically report its location to the property listing platform service 127 via the network 121 to facilitate geolocation of the device.

In box 348, the property listing platform service 127 determines that the location of the device matches a location or geofence of the property. That is, the user of the device is at the property location. In some cases, the user may merely drive by the location, and this can be determined as well and credited as a visit or partial visit. In box 351, the property listing platform service 127 may generate one or more notifications to the offeror of the property (e.g., the seller or lessor), one or more team members 169 of the offeror of the property, a listing agent, and/or one or more team members 178 of the listing agent. These notifications include an identification of the buyer agent 148 or indicate that the buyer is unrepresented.

However, these notifications do not include an identification of the user (e.g., any personally identifying information). The notifications may include metrics or other characteristics of the user that are not personally identifying, such as length of time that the user has interacted with the user interface corresponding to the property listing, length of time that the user visited the property location, prequalification status 151, and so forth. The notifications may be sent by text message, phone call, a data feed in a web page, a social network system 118, email, or via other communications media.

The notifications may be sent based at least in part on selection criteria specified by the recipient or another user. For example, the seller's agent may designate that all of his or her notifications for one or more listings are to be copied to an associate who is a team member 178. The selection criteria may include thresholds for expression of interest (e.g., time spent looking at the listing or visiting), thresholds for prequalification status 151, and/or other selection criteria. Where a user receives several notifications via a data feed, the notifications may be ranked by various ranking criteria such as prequalification status 151, seriousness as expressed by levels of interest (e.g., length of engagement or quantity of engagements), asking price of the listing, recency, and/or other user-specified criteria.

The notification may include a quantity of previous visits to the property by the user, as well as metrics detailing the user's engagement with the electronic property listing. In box 354, the property listing platform service 127 increments a record of the user's visits to the property in the physical visit history 154. In box 357, the property listing platform service 127 may add the property to the user's property watchlist 166.

Notifications may also be sent to the user's agent (i.e., the buyer agent 148), one or more team members 178 of the buyer's agent, and/or one or more team members 145 of the user. These notifications may include an identification of the user so that the buyer's agent or others may personally follow up with the user. The notifications may include metrics or other characteristics of the user, such as visit length, engagement duration with the listing, and so forth. The notifications may be sent by text message, phone call, a data feed in a web page, a social network system 118, email, or via other communications media. The notifications may be triggered by a positive action taken by the user, e.g., selecting a user interface component labeled “notify my team about my visit.”

In box 360, the property listing platform service 127 determines that the user has exited the property location. For example, the periodically reported location of the buyer client device 109 may indicate a different location from the property location. In box 363, the property listing platform service 127 may generate one or more notifications, which may be similar to those described relative to box 351 but prompted upon the user's leaving the property.

In box 366, the property listing platform service 127 may record the time spent by the user in visiting the property in the physical visit history 154 and/or the visit data 192. One or more notifications to the seller, seller's team members 169, the seller's agent 172, and/or the agent's team members 178 may include the length of the visit by the user and/or metrics across multiple users as to visit duration.

At a predefined time relative to a completion of the visit, a request for feedback about the property may be sent to the buyer client device 109. If showing feedback is provided, the feedback is reviewable by the seller's team, including the seller, the seller's team members 169, the seller's agent, and the agent's team members 178. Thereafter, the operation of the portion of the property listing platform service 127 ends.

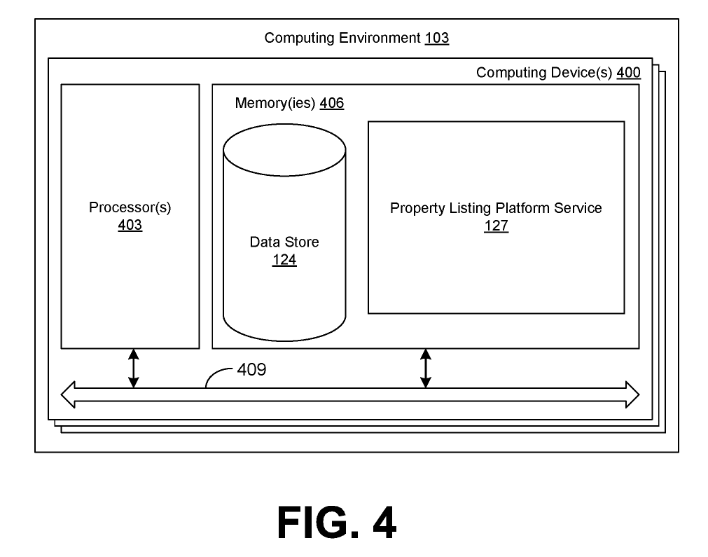

With reference to FIG. 4, shown is a schematic block diagram of the computing environment 103 according to an embodiment of the present disclosure. The computing environment 103 includes one or more computing devices 400. Each computing device 400 includes at least one processor circuit, for example, having a processor 403 and a memory 406, both of which are coupled to a local interface 409. To this end, each computing device 400 may comprise, for example, at least one server computer or like device. The local interface 409 may comprise, for example, a data bus with an accompanying address/control bus or other bus structure as can be appreciated.

Stored in the memory 406 are both data and several components that are executable by the processor 403. In particular, stored in the memory 406 and executable by the processor 403 are the property listing platform service 127 and potentially other applications. Also stored in the memory 406 may be a data store 124 and other data. In addition, an operating system may be stored in the memory 406 and executable by the processor 403.

It is understood that there may be other applications that are stored in the memory 406 and are executable by the processor 403 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 406 and are executable by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as including both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 403 may represent multiple processors 403 and/or multiple processor cores and the memory 406 may represent multiple memories 406 that operate in parallel processing circuits, respectively. In such a case, the local interface 409 may be an appropriate network that facilitates communication between any two of the multiple processors 403, between any processor 403 and any of the memories 406, or between any two of the memories 406, etc. The local interface 409 may comprise additional systems designed to coordinate this communication, including, for example, performing load balancing. The processor 403 may be of electrical or of some other available construction.

Although the property listing platform service 127 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3A-3D show the functionality and operation of an implementation of portions of the property listing platform service 127. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 403 in a computer system or other system. The machine code may be converted from the source code, etc. If embodied in hardware, each block may represent a circuit or a number of interconnected circuits to implement the specified logical function(s).

Although the flowcharts of FIGS. 3A-3D show a specific order of execution, it is understood that the order of execution may differ from that which is depicted. For example, the order of execution of two or more blocks may be scrambled relative to the order shown. Also, two or more blocks shown in succession in FIGS. 3A-3D may be executed concurrently or with partial concurrence. Further, in some embodiments, one or more of the blocks shown in FIGS. 3A-3D may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the property listing platform service 127, that comprises software or code can be embodied in any non-transitory computer-readable medium for use by or in connection with an instruction execution system such as, for example, a processor 403 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the property listing platform service 127, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 400, or in multiple computing devices 400 in the same computing environment 103.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in at least one computing device, wherein when executed the program causes the at least one computing device to at least:
determine that a first user has expressed an interest in a listing for a property;
determine an agent associated with the first user;
generate a first notification to an offeror of the property or to a listing agent of the property; and
generate a second notification to a second user that also has expressed interest in the property or to an agent associated with the second user, the second user being unassociated with the first user, the first notification and the second notification including an identification of the agent associated with the first user and excluding an identification of the first user.

2. The non-transitory computer-readable medium of claim 1, wherein when executed the program further causes the at least one computing device to at least:
generate a third notification to the agent associated with the first user or to another user associated with the first user, the other notification including the identification of the first user.

3. The non-transitory computer-readable medium of claim 1, wherein determining that the first user has expressed the interest further comprises:
determining that the first user has added the listing to a property watchlist via a user interface; or
determining that the first user has interacted with the user interface corresponding to the listing for the property beyond a threshold time, the notification including an amount of time that the first user has interacted with the user interface corresponding to the listing for the property.

4. The non-transitory computer-readable medium of claim 1, wherein determining that the first user has expressed the interest further comprises:
monitoring a location of the first user via a location-finding subsystem of a mobile device;
determining that the location of the first user corresponds to a location of the property; and
wherein the notification includes an amount of time that the first user visited the location of the property.

5. The non-transitory computer-readable medium of claim 1, wherein when executed the program further causes the at least one computing device to at least:
determine a list of friends of the first user on a social network;
determine a set of agents previously used by one or more of the list of friends to purchase or rent property; and
send a recommendation of one or more of the set of agents to the first user.

6. A system, comprising:
at least one computing device; and
at least one application executable in the at least one computing device, wherein when executed the at least one application causes the at least one computing device to at least:
receive a request for property information from a user;
generate a user interface configured to render a description of a property, wherein the description of the property indicates whether at least one showing of the property to another user is scheduled and whether at least one active offer for the property has been submitted by the other user; and
send data encoding the user interface to a client device via a network.

7. The system of claim 6, wherein when executed the at least one application further causes the at least one computing device to at least:
receive criteria for a property listing search from the user;
identify a plurality of properties that meet the criteria from a property listing data store;
rank the plurality of properties according to the criteria; and
generate another user interface configured to render a description of a corresponding property of the plurality of properties, wherein the description of the corresponding property indicates whether at least one showing of the corresponding property to the other user is scheduled and whether at least one active offer for the corresponding property has been submitted by the other user.

8. The system of claim 7, wherein when executed the at least one application further causes the at least one computing device to at least rank the plurality of properties further based at least in part on a set of properties in the property listing data store that the user or another user associated with the user has physically visited.

9. The system of claim 7, wherein when executed the at least one application further causes the at least one computing device to at least rank the plurality of properties further based at least in part on a corresponding amount of time that the user has interacted with a corresponding user interface for a respective one of the plurality of properties.

10. The system of claim 6, wherein when executed the at least one application further causes the at least one computing device to at least disable a showing scheduling function for the property in response to determining that a prequalified loan amount for the user is lower than the respective asking price of the property.

11. The system of claim 6, wherein the user interface includes a component configured to facilitate scheduling a showing of the property at an allowable time, and the allowable time is determined based at least in part on an adjacency to the at least one showing of the property to the other user, and the user interface excludes a time of the at least one showing.

12. The system of claim 6, wherein the user interface includes a component configured to facilitate sending an offer to buy or rent the property.

13. The system of claim 6, wherein the property already has an outstanding offer, and the user interface includes a component configured to facilitate sending a backup offer to buy or rent the property.

14. A method, comprising:
determining that a first user has physically visited a location of property listed for sale or lease via geolocation of a mobile device associated with the first user or that the first user has interacted with an electronic user interface corresponding to a listing of the property beyond a threshold time;
determining an agent associated with the first user;
generating a first notification to an offeror of the property or to a listing agent of the property; and
generating a second notification to a second user that also has expressed interest in the property or to an agent associated with the second user, the second user being unassociated with the first user, the first notification and the second notification including an identification of the agent associated with the first user and excluding an identification of the first user.

15. The method of claim 14, wherein the first notification includes a ranking associated with the first user indicating a level of interest of the first user as compared to the second user.

16. The method of claim 14, further comprising sending a request for feedback about the property to the mobile device at a predefined time relative to a completion of a visit of the first user to the property.

17. The method of claim 14, further comprising sending a third notification to the agent associated with the first user, the third notification identifying the property and the first user.

18. The method of claim 14, further comprising:
determining from an updated location of the first user that the first user has left the property; and
generating a third notification to the offeror of the property or to the listing agent indicating that the first user has left the property.

19. The method of claim 14, further comprising:
tracking a visit duration of the first user at the property via a location-finding subsystem of the mobile device; and
wherein the first notification includes the visit duration.

20. The method of claim 14, further comprising:
identifying a quantity of previous visits of the first user to the property from a data store; and
wherein the first notification indicates the quantity of previous visits.
